(19) United States
(12) Patent Application Publication
(10) Pub. No.: US 2019/0233623 A1
(43) Pub. Date: Aug. 1, 2019

(54) RUBBER COMPOSITION FOR TIRE AND PNEUMATIC TIRE

(71) Applicant: Toyo Tire Corporation, Itami-shi (JP)

(72) Inventor: Yuma Nishikawa, Itami-shi (JP)

(73) Assignee: Toyo Tire Corporation, Itami-shi (JP)

(21) Appl. No.: 16/253,922

(22) Filed: Jan. 22, 2019

(30) Foreign Application Priority Data
Jan. 31, 2018 (JP) 2018-014611

(51) Int. Cl. C08L 9/00; C08L 7/00; B60C 1/00; C08K 5/101; C08K 5/42; C08K 5/521

(52) U.S. Cl. CPC C08L 9/00; C08L 7/00; B60C 1/0016; C08K 3/36; C08K 5/42; C08K 5/521; C08L 2312/02; C08K 5/101

(57) ABSTRACT

On-ice performance is improved. A rubber composition for a tire comprising 100 parts by mass of a rubber component comprising a diene rubber, 10 to 70 parts by mass of carbon black, less than 10 parts by mass (including 0 part by mass) of silica, and an ether ester compound having HLB of 10 or less represented by the following formula (1):

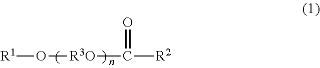

wherein R¹ and R² each independently represent a hydrocarbon group having 1 to 30 carbon atoms, R³ represents an alkylene group having 2 to 4 carbon atoms, n is an average number of moles of oxyalkylene groups added and 60 mass % or more of (R³O)ₙ consists of an oxyethylene group, is disclosed. Furthermore, a pneumatic tire having a treat comprising the rubber composition is disclosed.

### CROSS-REFERENCE TO RELATED APPLICATIONS

This application is based upon and claims the benefit of priority from the prior Japanese Patent Application No. 2018-14611, filed on Jan. 31, 2018; the entire contents of which are incorporated herein by reference.

### BACKGROUND

### 1. Technical Filed

The present invention relates to a rubber composition for a tire and a pneumatic tire using the rubber composition.

### 2. Related Art

A rubber composition for forming a tread of a winter tire such as a studless tire is required to improve running performance on ice road surface (that is, on-ice performance).

For example, JP-A-2016-023213 proposes adding 10 parts by mass or more of silica to 100 parts by mass of a diene rubber and additionally adding glycerin mono-fatty acid ester and thermally expandable microcapsules thereto in order to improve on-ice performance together with breaking performance on a wet road surface (that is, wet performance) in a rubber composition for a studless tire. However, JP-A-2016-023213 does not describe adding polyoxyethylene alkyl ether fatty acid ester.

On the other hand, JP-A-10-330539 discloses adding a polyoxyalkylene glycol compound to a rubber composition using white filler, that is, silica, as a filler. However, JP-A-10-330539 is that a polyoxyalkylene glycol compound was added to a rubber composition using silica as main filler in place of carbon black having excellent conductivity in order to impart antistatic performance to the rubber composition. JP-A-10-330539 does not describe adding a polyoxyalkylene glycol compound to a rubber composition using carbon black as main filler and improving on-ice performance by the addition.

### SUMMARY

In view of the above, an object of an embodiment of the present invention is to provide a rubber composition for a tire that can improve on-ice performance.

The rubber composition for a tire according to an embodiment of the present invention comprises 100 parts by mass of a rubber component comprising a diene rubber, 10 to 70 parts by mass of carbon black, less than 10 parts by mass (including 0 part by mass) of silica, and an ether ester compound having HLB of 10 or less represented by the following general formula (1):

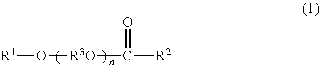

wherein R¹ and R² each independently represent a hydrocarbon group having 1 to 30 carbon atoms, R³ represents an alkylene group having 2 to 4 carbon atoms, n is an average number of moles of oxyalkylene groups added and 60 mass % or more of (R³O)ₙ consists of an oxyethylene group.

A pneumatic tire according to an embodiment of the present invention comprises a tread comprising the rubber composition.

According to the embodiment of the present invention, on-ice performance and processability can be improved by adding the ether ester compound.

### DETAILED DESCRIPTION

The rubber composition according to the present embodiment comprises a rubber component comprising a diene rubber, having added thereto carbon black and a specific ether ester compound.

The diene rubber as the rubber component is not particularly limited. Examples of the diene rubber include various diene rubbers generally used in a rubber composition, such as natural rubber (NR), synthetic isoprene rubber (IR), butadiene rubber (BR), styrene-butadiene rubber (SBR), nitrile rubber (NBR), chloroprene rubber (CR), butyl rubber (IIR), styrene-isoprene copolymer rubber, butadiene-isoprene copolymer rubber and styrene-isoprene-butadiene copolymer rubber. Those diene rubbers can be used in one kind alone or as mixtures of two or more kinds.

The rubber component according to one preferred embodiment comprises natural rubber and butadiene rubber. For example, 100 parts by mass of the rubber component comprise 30 to 80 parts by mass of natural rubber and 20 to 70 parts by mass of butadiene rubber, and preferably 40 to 70 parts by mass of natural rubber and 30 to 60 parts by mass of butadiene rubber.

The carbon black as a filler is not particularly limited and can use various kinds of carbon black to be added to a rubber composition. Examples of the carbon black that can be used include SAF grade (N100 Series), ISAF grade (N200 Series), HAF grade (N300 Series) and FEF grade (N500 Series) (those are all ASTM grade).

The amount of the carbon black added is preferably 10 to 70 parts by mass per 100 parts by mass of the rubber component. The amount of the carbon black is more preferably 20 parts by mass or more and still more preferably 30 parts by mass or more, and is more preferably 60 parts by mass or less and still more preferably 50 parts by mass or less. In the present invention, carbon black is preferably used as main filler. In other words, the amount of carbon black in the filler is preferably more than 50 mass % and more preferably more than 70 mass %, based on the mass of the filler.

The filler may be carbon black alone, but a small amount of silica may be used in the filler. Specifically, in the rubber composition of the present invention, silica may not be contained, and when silica is contained, the amount thereof is less than 10 parts by mass per 100 parts by mass of the rubber component. The same can apply to other white fillers such as aluminum hydroxide, magnesium hydroxide, magnesium oxide, titanium oxide, talc and clay. Specifically, the white filler such as silica may not be contained in the rubber composition of the present embodiment, and when the white filler is contained, the white filler may be contained in an amount of less than 10 parts by mass per 100 parts by mass of the rubber component.

The silica is not particularly limited, and for example, wet silica such as silica by wet precipitation method or silica by wet gelation method may be used. The amount of silica added is 1 to 8 parts by mass per 100 parts by mass of the rubber component.

The rubber composition according to the present embodiment contains an ether ester compound (preferably polyoxyalkylene alkyl ether fatty acid ester) having HLB of 10 or less represented by the following general formula (1). The ether ester compound shows plasticization effect in the rubber composition. It is therefore considered that a viscosity during kneading the rubber composition is reduced and as a result, processability can be improved. Furthermore, it is considered that a solidification temperature is decreased by optimizing the proportion of an oxyalkylene group such that HLB of the ether ester compound is 10 or less and the ether ester compound functions as a plasticizer in the rubber composition even at low temperature. As a result, rubber flexibility at low temperature is maintained and on-ice performance is improved.

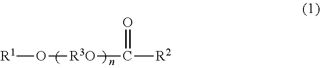

In the formula (1), R¹ and R² each independently represent a hydrocarbon group having 1 to 30 carbon atoms. The carbon atoms in the hydrocarbon group are preferably 5 to 25, more preferably 8 to 22 and still more preferably 10 to 20. The hydrocarbon group is preferably a linear or branched saturated or unsaturated aliphatic hydrocarbon group, and preferred examples thereof include an alkyl group and an alkenyl group. In one embodiment, R¹ is preferably an alkyl group or alkenyl group having 1 to 25 carbon atoms and more preferably an alkyl group or alkenyl group having 8 to 20 carbon atoms. R² is preferably an alkyl group or alkenyl group having 8 to 25 carbon atoms and more preferably an alkyl group or alkenyl group having 12 to 20 carbon atoms.

In the formula (1), R³ represents an alkylene group having 2 to 4 carbon atoms and n represents an average number of moles of oxyalkylene groups added. The alkylene group of R³ may be a linear or branched alkylene group. Examples of the oxyalkylene group represented by R³O include an oxyethylene group, an oxypropylene group and an oxybutylene group. (R³O)ₙ in the formula (1) is a polyoxyalkylene chain obtained by addition polymerization of alkylene oxide having 2 to 4 carbon atoms (for example, ethylene oxide, propylene oxide and butylene oxide). Polymerization form of alkylene oxide and the like is not particularly limited, and may be a homopolymer, a random copolymer or a block copolymer.

(R³O)ₙ in the formula (1) mainly preferably comprises an oxyethtylene group, and 60 mass % or more of (R³O)ₙ preferably consists of an oxyethylene group. Specifically, the polyoxyalkylene chain represented by (R³O)ₙ contains an oxyethylene group in an amount of preferably 60 mass % or more and more preferably 80 mass % or more (the entire oxyalkylene groups constituting the polyoxyalkylene chain is 100 mass %). Particularly preferably, the polyoxyalkylene chain contains 100 mass % of the oxyethylene group, that is, consists of only the oxyethylene group as shown in the following general formula (2):

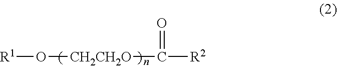

In the formula (2), R¹, R² and n are the same as defined in R¹, R² and n in the formula (1).

The n showing the average number of the oxyalkylene group added is the number set such that HLB of the ether ester compound is 10 or less. The n may be 1 to 20, may be 2 to 15 or may be 3 to 10, although varying depending on the kind of R¹ and R².

The HLB (Hydrophile-Lipophile Balance) of the ether ester compound is 10 or less for decreasing a solidification temperature at low temperature as described above. The HLB is preferably 3 to 10 and more preferably 4 to 8. The HLB used herein is a value calculated from the following Griffin's formula. The proportion of a hydrophilic moiety occupied in the whole molecule is large and hydrophilicity is high, as the value is large.

HLB=20×(Molecular weight of hydrophilic moiety)/(Whole molecular weight)

wherein the molecular weight of the hydrophilic moiety is the molecular weight of a polyoxyalkylene chain represented by (R³O)ₙ.

The amount of the ether ester compound added of the formula (1) is not particularly limited, but is preferably 1 to 10 parts by mass and more preferably 2 to 8 parts by mass, per 100 parts by mass of the rubber component. When the amount of the ether ester compound added is too large, rigidity of a vulcanized rubber tends to decrease. Therefore, the amount of the ether ester compound added is preferably 10 parts by mass or less from the standpoint of driving stability.

The rubber composition according to the present invention may further comprise a liquid plasticizer having a pour point of 5° C. or lower. When the liquid plasticizer having a pour point of 5° C. or lower is used, on-ice performance can be further improved, coupled with the use of the ether ester compound. The pour point of the liquid plasticizer is preferably 0° C. or lower from the standpoint of on-ice performance. The lower limit of the pour point is not particularly limited, but may be −70° C. The pour point used herein is a value measured according to JIS K2269:1987, and was measured by an automatic pour point tester manufactured by Rigo Co., Ltd. in the Examples described hereinafter.

Examples of the liquid plasticizer include oil, a carboxylic acid ester plasticizer (for example, phthalic acid ester or adipic acid ester), a phosphoric acid ester plasticizer (for example, trimethyl phosphate or triethyl phosphate) and a sulfonic acid ester plasticizer (for example, benzene sulfone butyl amide or toluene sulfone amide). Examples of the oil include mineral oils such as paraffin process oil, naphthene process oil and aromatic process oil.

The amount of liquid plasticizer added is not particularly limited, but is preferably 5 to 40 parts by mass and more preferably 10 to 30 parts by mass, per 100 parts by mass of the rubber component.

The rubber composition according to the present embodiment may further comprise a polymer gel that is crosslinked diene polymer particles. When the polymer gel is added, processability and on-ice performance can be further improved.

The polymer gel is a gelled rubber that can be produced by crosslinking a rubber dispersion. Examples of the rubber dispersion include a rubber latex produced by emulsion polymerization and a rubber dispersion obtained by emulsifying a solution-polymerized rubber in water. Examples of a crosslinking agent for crosslinking the rubber dispersion include organic peroxide, an organic azo compound and a sulfur crosslinking agent.

Examples of the diene polymer constituting the polymer gel include natural rubber polymer, polyisoprene, a styrene-butadiene copolymer, polybutadiene, a styrene-isoprene copolymer, a butadiene-isoprene copolymer and a styrene-isoprene-butadiene copolymer. Those may be used alone or as mixtures of two or more kinds. The diene polymer preferably comprises polybutadiene and a styrene-butadiene copolymer as main components.

The polymer gel may use a polymer gel having a functional group containing a hetero atom. Examples of the functional group include at least one selected from the group consisting of a hydroxy group, an amino group, a carboxy group, and an alkoxyl group and an epoxy group.

The amount of polymer gel added is not particularly limited, but is preferably 1 to 10 parts by mass and more preferably 2 to 8 parts by mass, per 100 parts by mass of the rubber component. The polymer gel is not included in the rubber components described above.

The rubber composition according to the present embodiment can further contain various additives generally used in a rubber composition, such as zinc flower, stearic acid, an age resister, a wax, a vulcanizing agent and, a vulcanization accelerator, other than the above-described components. Furthermore, to further improve on-ice performance, antislip materials (for example, vegetable granules such as a ground product of walnut, and a ground product of porous carbonized material of plants, such as a ground product of bamboo charcoal) may be added to the rubber composition.

Sulfur is preferably used as the vulcanizing agent. The amount of the vulcanizing agent added is not particularly limited, but is preferably 0.1 to 10 parts by mass and more preferably 0.5 to 5 parts by mass, per 100 parts by mass of the rubber component. Examples of the vulcanization accelerator include various vulcanization accelerators such as a sulfenamide type, a thiuram type, a thiazole type and a guanidine type. Those can be used alone or as mixtures of two or more kinds thereof. The amount of the vulcanization accelerator is not particularly limited, but is preferably 0.1 to 7 parts by mass and more preferably 0.5 to 5 parts by mass, per 100 parts by mass of the rubber component.

The rubber composition according to the present invention can be prepared by kneading the necessary components according to the conventional method using a mixing machine generally used, such as Banbury mixer, a kneader or rolls. Specifically, for example, additives other than a vulcanizing agent and a vulcanization accelerator are added to a rubber component together with a filler, an ether ester compound, and a liquid plasticizer and a polymer gel as optional components, followed by mixing, in a first mixing steep (non-productive mixing step). A vulcanizing agent and a vulcanization accelerator are added to the mixture thus obtained, followed by mixing, in a final mixing step (productive mixing step). Thus, an unvulcanized rubber composition can be prepared.

The rubber composition according to the present embodiment can be used in, for example, tires for various uses, such as for passenger cars or for heavy load of trucks or buses. The rubber composition is preferably used in a tread of a pneumatic tire, that is, is a rubber composition for a tire tread. The rubber composition according to the present embodiment has excellent on-ice performance as described above and is therefore preferably used as a rubber composition for a tread of winter tires such as a studless tire and a snow tire (that is, a rubber composition for a tread of winter tires).

The pneumatic tire according to one embodiment can be produced by preparing a tread rubber of a tire by an extruder for rubber using the rubber composition, forming an unvulcanized tire (green tire) by combining with other tire members, and then vulcanization molding the unvulcanized tire at a temperature of, for example, 140 to 180° C. In the case where a rubber composition is used in a pneumatic tire having cap/base structure, the rubber composition of the present embodiment may be used in only a cap tread at a ground-contact side surface of a tire.

### Examples

The present invention is described in detail below by reference to Examples, but the invention is not construed as being limited to those Examples.

Synthesis of Ether Ester Compound

Compounds 1 to 5 used in Examples and Comparative Examples were synthesized by the following methods.

Compound 1

0.1 g of a potassium hydroxide catalyst was added to 47 g (0.25 mol) of lauryl alcohol (manufactured by Tokyo Chemical Industry Co., Ltd.), 33 g (0.75 mol) of ethylene oxide (manufactured by Tokyo Chemical Industry Co., Ltd.) was injected to the resulting mixture while stirring the mixture at 110 to 120° C., and an addition reaction was conducted. The resulting reactant was transferred to a flask, and potassium hydroxide as the catalyst was neutralized with phosphoric acid. A phosphoric acid salt was filtered off from the resulting neutralized product and 72 g of lauryl alcohol-ethylene oxide three-molar adduct was obtained (yield: 90 mass %). 60 g (0.19 mol) of the lauryl alcohol-ethylene oxide three-molar adduct obtained, 56 g (0.2 mol) of oleic acid (manufactured by Tokyo Chemical Industry Co., Ltd.) and 0.7 g of dibutyltin oxide as a catalyst were weighed, an esterification reaction was conducted through dehydration at 225° C. while stirring under nitrogen blowing, and Compound 1 was obtained. Compound 1 is an ether ester compound having the formula (2) wherein R¹ is C₁₂H₂₅, R² is C₁₇H₃₃, n is 3 and HLB is 5.

Compound 2

0.1 g of a potassium hydroxide catalyst was added to 47 g (0.25 mol) of lauryl alcohol (manufactured by Tokyo Chemical Industry Co., Ltd.), 33 g (1.5 mol) of ethylene oxide (manufactured by Tokyo Chemical Industry Co., Ltd.) was injected to the resulting mixture while stirring the mixture at 110 to 120° C., and an addition reaction was conducted. The resulting reactant was transferred to a flask, and potassium hydroxide as the catalyst was neutralized with phosphoric acid. A phosphoric acid salt was filtered off from the resulting neutralized product and 150 g of lauryl alcohol-ethylene oxide six-molar adduct was obtained (yield: 84 mass %). 135 g (0.19 mol) of the lauryl alcohol-ethylene oxide six-molar adduct obtained, 56 g (0.2 mol) of oleic acid (manufactured by Tokyo Chemical Industry Co., Ltd.) and 0.7 g of dibutyltin oxide as a catalyst were weighed, an esterification reaction was conducted through dehydration at 225° C. while stirring under nitrogen blowing, and Compound 2 was obtained. Compound 2 is an ether ester compound having the formula (2) wherein R¹ is C₁₂H₂₅, R² is C₁₇H₃₃, n is 6 and HLB is 7.

Compound 3

0.1 g of a potassium hydroxide catalyst was added to 47 g (0.25 mol) of lauryl alcohol (manufactured by Tokyo Chemical Industry Co., Ltd.), 330 g (7.5 mol) of ethylene oxide (manufactured by Tokyo Chemical Industry Co., Ltd.) was injected to the resulting mixture while stirring the mixture at 110 to 120° C., and an addition reaction was conducted. The resulting reactant was transferred to a flask, and potassium hydroxide as the catalyst was neutralized with phosphoric acid. A phosphoric acid salt was filtered off from the resulting neutralized product and 336 g of lauryl alcohol-ethylene oxide thirty-molar adduct was obtained (yield: 76 mass %). 200 g (0.11 mol) of the lauryl alcohol-ethylene oxide thirty-molar adduct obtained, 34 g (0.12 mol) of oleic acid (manufactured by Tokyo Chemical Industry Co., Ltd.) and 0.7 g of dibutyltin oxide as a catalyst were weighed, an esterification reaction was conducted through dehydration at 225° C. while stirring under nitrogen blowing, and Compound 3 was obtained. Compound 3 is an ether ester compound having the formula (2) wherein R¹ is C₁₂H₂₅, R² is C₁₇H₃₃, n is 30 and HLB is 15.

Compound 4

0.1 g of a potassium hydroxide catalyst was added to 30 g (0.15 mol) of dodecyl alcohol (manufactured by Tokyo Chemical Industry Co., Ltd.), 46 g (1.05 mol) of ethylene oxide (manufactured by Tokyo Chemical Industry Co., Ltd.) was injected to the resulting mixture while stirring the mixture at 110 to 120° C., and an addition reaction was conducted. The resulting reactant was transferred to a flask, and potassium hydroxide as the catalyst was neutralized with phosphoric acid. A phosphoric acid salt was filtered off from the resulting neutralized product and 64 g of dodecyl alcohol-ethylene oxide seven-molar adduct was obtained (yield: 85 mass %). 60 g (0.12 mol) of the dodecyl alcohol-ethylene oxide seven-molar adduct obtained, 37 g (0.13 mol) of stearic acid (manufactured by Tokyo Chemical Industry Co., Ltd.) and 0.7 g of dibutyltin oxide as a catalyst were weighed, an esterification reaction was conducted through dehydration at 225° C. while stirring under nitrogen blowing, and Compound 4 was obtained. Compound 4 is an ether ester compound having the formula (2) wherein R¹ is C₁₃H₂₇, R² is C₁₇H₃₅, n is 7 and HLB is 8.

Compound 5

0.1 g of a potassium hydroxide catalyst was added to 54 g (0.2 mol) of oleyl alcohol (manufactured by Tokyo Chemical Industry Co., Ltd.), 26 g (0.6 mol) of ethylene oxide (manufactured by Tokyo Chemical Industry Co., Ltd.) was injected to the resulting mixture while stirring the mixture at 110 to 120° C., and an addition reaction was conducted. The resulting reactant was transferred to a flask, and potassium hydroxide as the catalyst was neutralized with phosphoric acid. A phosphoric acid salt was filtered off from the resulting neutralized product and 69 g of oleyl alcohol-ethylene oxide three-molar adduct was obtained (yield: 90 mass %). 58 g (0.15 mol) of the oleyl alcohol-ethylene oxide three-molar adduct obtained, 47 g (0.165 mol) of stearic acid (manufactured by Tokyo Chemical Industry Co., Ltd.) and 0.7 g of dibutyltin oxide as a catalyst were weighed, an esterification reaction was conducted through dehydration at 225° C. while stirring under nitrogen blowing, and Compound 5 was obtained. Compound 5 is an ether ester compound having the formula (2) wherein R¹ is C₁₈H₃₅, R² is C₁₇H₃₅, n is 3 and HLB is 4.

Manufacturing and Evaluation of Rubber Composition and Tire

Banbury mixer was used. Compounding ingredients excluding sulfur and a vulcanization accelerator were added to a rubber component according to the formulations (parts by mass) shown in Table 1 below, followed by kneading, in a first mixing step (discharge temperature: 160° C.). Sulfur and a vulcanization accelerator were added to the kneaded mixture obtained above, followed by kneading, in a final mixing step (discharge temperature: 90° C.). Thus, a rubber composition was prepared. The details of each component in Table 1 are as follows.

NR: RSS#3

BR: “BR150B” manufactured by Ube Industries, Ltd.

Silica: “NIPSIL AQ” manufactured by Tosoh Silica Corporation

Carbon black: “DIABLACK N234” manufactured by Mitsubishi Chemical Corporation

Oil: “JOMO PROCESS P200” (pour point: −10° C. or lower) manufactured by JX Nippon Oil & Sun-Energy Corporation

Polymer gel: “NANOPRENE M20” manufactured by LANXESS

Zinc flower: “Zinc Flower #1” manufactured by Mitsui Mining & smelting Co., Ltd.

Age resister: “NOCRAC 6C” manufactured by Ouchi Shinko Chemical Industrial Co., Ltd.

Stearic acid: “LUNAC S-20” manufactured by Kao Corporation

Wax: “OZOACE 0355” manufactured by Nippon Seiro Co., Ltd.

Sulfur: “POWDERED SULFUR” manufactured by Tsurumi Chemical Industry Co., Ltd.

Vulcanization accelerator 1: “NOCCELER D” manufactured by Ouchi Shinko Chemical Industrial Co., Ltd.

Vulcanization accelerator 2: “SOXINOL CZ” manufactured by Sumitomo Chemical Co., Ltd.

Processability of each rubber composition obtained was evaluated, and a pneumatic radial tire (tire size: 195/65R15) was manufactured using each rubber composition as a tread rubber and vulcanization molding according to the conventional method. On-ice performance of the test tire thus obtained was evaluated. Each measurement and evaluation methods are as follows.

Processability: An vulcanized rubber was preheated at 100° C. for 1 minute and a torque value after 4 minutes was measured in Mooney unit using a rotorless Mooney viscometer manufactured by Toyo Seiki Co., Ltd. according to JIS K6300. Inverse number of the measurement value was indicated by an index as the value of Comparative Example 1 being 100. Larger index means that Mooney viscosity is low and processability is excellent.

On-ice performance: Four test tires were mounted on a 4WD car of 2,000 cc displacement. ABS was operated from 40 km/hr running on an ice floe road (air temperature: −3±3° C.) and a braking distance was measured (average value of n=10). Inverse number of a breaking distance was indicated by an index as the value of Comparative Example 1 being 100. Larger index means that a breaking distance is short and breaking performance on an ice-covered road surface is excellent.

TABLE 1

| | Com. | Com. | | | | | | |
|---|---|---|---|---|---|---|---|---|
| | Ex. 1 | Ex. 2 | Ex. 1 | Ex. 2 | Ex 3 | Ex. 4 | Ex. 5 | Ex. 6 |
| Formulations | | | | | | | | |
| (parts by mass) | | | | | | | | |
| NR | 60 | 60 | 60 | 60 | 60 | 60 | 60 | 60 |
| BR | 40 | 40 | 40 | 40 | 40 | 40 | 40 | 40 |
| Carbon black | 40 | 40 | 40 | 40 | 40 | 40 | 40 | 40 |
| Silica | 5 | 5 | 5 | 5 | 5 | 5 | 5 | 5 |
| Oil | 20 | 20 | 20 | 20 | 20 | 20 | 20 | 20 |
| Polymer gel | | | | 5 | | | | |
| Zinc flower | 2 | 2 | 2 | 2 | 2 | 2 | 2 | 2 |
| Age resister | 2 | 2 | 2 | 2 | 2 | 2 | 2 | 2 |
| Stearic acid | 2 | 2 | 2 | 2 | 2 | 2 | 2 | 2 |
| Wax | 2 | 2 | 2 | 2 | 2 | 2 | 2 | 2 |
| Compound 1 | | | 5 | 5 | 8 | | | |
| (HLB = 4) | | | | | | | | |
| Compound 2 | | | | | | 5 | | |
| (HLB = 7) | | | | | | | | |
| Compound 3 | | 5 | | | | | | |
| (HLB = 15) | | | | | | | | |
| Compound 4 | | | | | | | 5 | |
| (HLB = 8) | | | | | | | | |
| Compound 5 | | | | | | | | 5 |
| (HLB = 5) | | | | | | | | |
| Sulfur | 2 | 2 | 2 | 2 | 2 | 2 | 2 | 2 |
| Vulcanization | 1.5 | 1.5 | 1.5 | 1.5 | 1.5 | 1.5 | 1.5 | 1.5 |
| accelerator 1 | | | | | | | | |
| Vulcanization | 1.5 | 1.5 | 1.5 | 1.5 | 1.5 | 1.5 | 1.5 | 1.5 |
| accelerator 2 | | | | | | | | |
| Evaluation | | | | | | | | |
| (Index) | | | | | | | | |
| Processability | 100 | 99 | 103 | 105 | 108 | 105 | 105 | 104 |
| On-ice | 100 | 80 | 111 | 114 | 117 | 108 | 106 | 109 |
| performance | | | | | | | | |

The results are shown in Table 1 above. Improvement effect of on-ice performance was not obtained in Comparative Example 2 in which an ether ester compound having high HLB (Compound 3) was added, as compared with Comparative Example 1. On the other hand, in Examples 1 to 6 in which an ether ester compound having HLB of 10 or less (Compounds 1, 2, 4 and 5) was added, both processability and on-ice performance were improved as compared with Comparative Example 1. Furthermore, further improvement effect in processability and on-ice performance was obtained in Example 2 by further adding a polymer gel, as compared with Example 1.

Some embodiments of the present invention are described above, but those embodiments are describe as examples and are not intended to limit the scope of the invention. Those embodiments can be carried out in other various modifications, and various omissions, replacements and changes can be made within a range that does not deviate from the gist of the invention. The omission, replacement, change and the like are included in the scope and gist of the invention, and are also included in the inventions described in the claims and their equivalent ranges.

What is claimed is:

1. A rubber composition for a tire comprises 100 parts by mass of a rubber component comprising a diene rubber, 10 to 70 parts by mass of carbon black, less than 10 parts by mass (including 0 part by mass) of silica, and an ether ester compound having HLB of 10 or less represented by the following general formula (1): 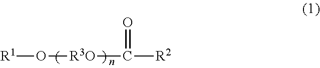
wherein R¹ and R² each independently represent a hydrocarbon group having 1 to 30 carbon atoms, R³ represents an alkylene group having 2 to 4 carbon atoms, n is an average number of moles of oxyalkylene groups added and 60 mass % or more of (R³O)ₙ consists of an oxyethylene group.

2. The rubber composition for a tire according to claim 1, wherein 100 parts by mass of the rubber component comprises 30 to 80 parts by mass of natural rubber and 20 to 70 parts by mass of butadiene rubber.

3. The rubber composition for a tire according to claim 1, wherein the amount of the ether ester compound added is 1 to 10 parts by mass per 100 parts by mass of the rubber component.

4. The rubber composition for a tire according to claim 1, further comprising a liquid plasticizer having a pour point of 5° C. or lower.

5. The rubber composition for a tire according to claim 4, wherein the liquid plasticizer is at least one selected from the group consisting of oil, a carboxylic acid ester plasticizer, a phosphoric acid ester plasticizer and a sulfonic acid ester plasticizer.

6. The rubber composition for a tire according to claim 1, further comprising a polymer gel that is crosslinked diene polymer particles.

7. A pneumatic tire having a tread comprising the rubber composition according to claim 1.

8. A pneumatic tire according to claim 7, which is a winter tire.
